(19) United States
(12) Patent Application Publication
(10) Pub. No.: US 2008/0124035 A1
(43) Pub. Date: May 29, 2008

(54) Cables

(76) Inventor: Philip Head, West Drayton (GB)

Correspondence Address: K.F. ROSS P.C., 5683 RIVERDALE AVENUE, SUITE 203 BOX 900, BRONX, NY, 10471-0900, US

(21) Appl. No.: 11/792,105

(22) PCT Filed: Dec. 1, 2005
(86) PCT No.: PCT/GB05/50226

§ 371 Date: May 31, 2007

(30) Foreign Application Priority Data
Dec. 1, 2004 (GB) 0426338.0
Jun. 1, 2005 (GB) 0511151.3

(51) Int. Cl. G02B 6/44; B23K 31/02

(52) U.S. Cl. 385/107; 228/164; 228/173.1

(57) ABSTRACT

A cable for use in a borehole or the like, comprises a fibre-optic line, concentrically surrounded by at least two metal layers capable of bearing a tensile load. Ideally, there are included three or four metal layers. The metal layer may be a steel layer or a copper beryllium layer. Also described is a method of making a cable according to any previous claim comprising the step of forming the metal layer from a strip and seam welding the strip along the strip's length, and swaging the metal layer to reduce its diameter onto the layer beneath.

### CROSS REFERENCE TO RELATED APPLICATIONS

This application is the US national phase of PCT application PCT/GB2005/050226, filed 1 Dec. 2005, published 8 Jun. 2006 as WO 2006/059158, and claiming the priority of British patent application 0426338.0 itself filed 1 Dec. 2004 and British patent application 0511151.3 itself filed 1 Jun. 2005, whose entire disclosures are herewith incorporated by reference.

This invention relates primarily but should not be limited to fibre optic cables which are used to provide telemetry in a borehole.

Fibre-optic data communication downhole is generally provided by a cable which is strapped to the outside of drillstring, coiled tubing or wireline. The fibre-optic cable is vulnerable to being damaged as the drillstring, coiled tubing or wireline is moved through the borehole.

It is an object of the present invention to provide a fibre optic data link downhole in a convenient manner.

According to the present invention, there is provided a cable for use in a borehole or the like, comprising a fibre-optic line, concentrically surrounded by at least two metal layers capable of bearing a tensile load.

According to another aspect of the present invention, there is provided a method of making a cable according to any previous claim comprising the step of forming the metal layer from a strip and seam welding the strip along the strip's length.

If a metal tube were welded around a fibre optic cable or electrical conductor, for the tubes relative diameter there would be a large internal diameter which results in a relatively low tensile strength steel clad cable.

It is another objective of this invention to use different materials for each layer. The first maybe Aluminium (an excellent barrier to gas) the second may be stainless or beryllium copper and the outer could be inconel.

By way of example the following figures will be used to describe two embodiments of the invention.

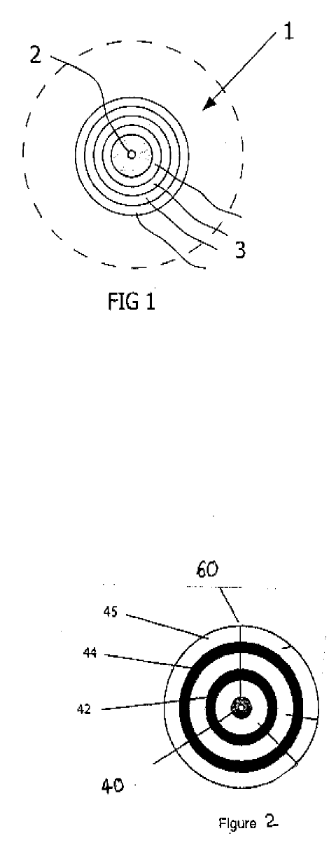

FIG. 1 is cross sectional view of a fibre-optic cable.

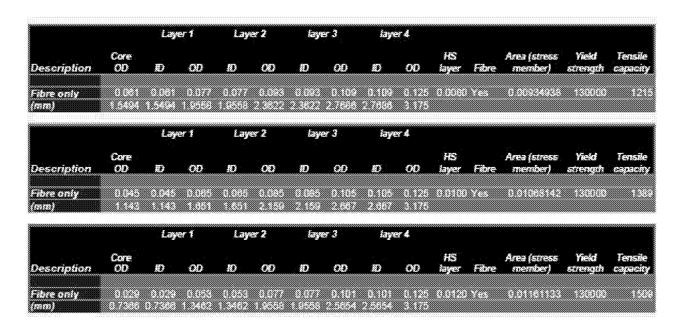

FIG. 2 is cross sectional view of another embodiment of a fibre-optic cable.

FIG. 3 is a table showing the calculated yield strength and tensile capacity fibre-optic cables for different metal layers.

Referring to FIG. 1, a fibre optic cable conveyance means comprises a multi skin slickline 1 which encases a fibre optic cable 2. The slickline is constructed using thin wall sheet stainless steel 3 (or other suitable weldable material) which is formed around the fibre seam welded and swaged to a snug fit. This is repeated many times to achieve a thick wall tube with high tensile load carrying capability. It would be difficult to form a single sheet of equivalent thickness to the required curvature, but by building up layer of thin sheets the same tensile strength can be achieved.

Referring to FIG. 2, the metal layers may be used to conduct electricity. An the inner core of fibre optic cable 40, is surrounded by a beryllium copper seam welded tube 43, outside this is an extruded insulation tube 42, outside this is a second beryllium copper seam welded tube 41, then outside this is a second insulated tube 44 with finally an outer layer of beryllium copper 45 is hermetically sealed to prevent wellbore fluids attacking the inner electrical carrying tubes 41 and 43. In this case the entire structure is beryllium copper to ensure equal expansion in the well and allow the entire structure to carry the tensile load. Because it is also a set of enclosed tubes it will be relatively stiff, and hence able to transfer compressive loads.

Referring to FIG. 3, this table shows calculated yield strength and tensile capacity of a fibre-optic cable having four metal layers formed in this way, when a single layer is 0.008 mm, 0.01 mm and 0.012 mm.

1. A cable for use in a borehole or the like, comprising a fibre-optic line, concentrically surrounded by at least two metal layers capable of bearing a tensile load.

2. The cable according to claim 1 wherein there are included three metal layers.

3. The cable according to claim 1 wherein there are included four metal layers.

4. The cable according to claim 1 wherein the metal layer is a steel layer.

5. The cable according to claim 1 wherein the metal layer is a copper beryllium layer.

6. A method of making a cable for use in a borehole or the like, comprising a fiber-optic link concentrically surrounded by at least two metal layers capable of bearing a tensile load, the method comprising the step of forming the metal layers from a strip and seam welding the strip along the strip's length.

7. The method of making a cable according to claim 6 comprising the step of swaging the metal layer to reduce its diameter onto the layer beneath.
